(19) United States
(12) Patent Application Publication
(10) Pub. No.: US 2013/0147817 A1
(43) Pub. Date: Jun. 13, 2013

(54) Systems and Methods for Reducing Clock Domain Crossings

(71) Applicant: Collis Quinn CARTER, Richmond Hill (CA)

(72) Inventor: Collis Quinn CARTER, Richmond Hill (CA)

(73) Assignee: ATI Technologies, ULC, Markham (CA)

(21) Appl. No.: 13/324,451

(22) Filed: Dec. 13, 2011

(51) Int. Cl. G06T 1/20

(52) U.S. Cl. 345/506

(57) ABSTRACT

In an embodiment, a graphics processing device is provided. The graphics processing device includes a global clock generator configured to generate a global clock signal and a plurality of graphics pipelines each configured to transmit image frames to a respective display device. Each of the graphics pipelines comprises a timing generator. Each of the timing generators is configured to generate a respective virtual clock signal based on the global clock signal and wherein each virtual clock signal is used to advance logic of a respective one of the display devices.

### BACKGROUND

1. Field

The present invention generally relates to display systems. Specifically, the present invention relates to clock signals in display systems.

2. Background Art

Graphics processing devices generate image frames to be displayed on one or more display devices. For example, graphics processing devices can be implemented in various computing devices (e.g., laptop computers, desktop computers, disc players (e.g., Blu-ray™ disc players), tablets, mobile devices (e.g., “smart” phones) and others) that are configured to display images on a computer monitor, television, embedded displays and/or other similar display devices. To display image frames on display devices, graphics processing devices include one or more graphics pipelines that process image frame data so that it can be displayed using a display device. For example, these graphics pipelines can format and encode image frames so that they can be displayed using a particular display device.

Graphics pipelines also often include timing generators that produce timing signals. These timing signals can be used to advance logic in display devices needed to control pixels that form the display. Often, each display device will require a clock signal at a specific rate. Thus, each of the timing generators is capable of producing a unique clock signal to advance the logic of a specific display device.

The presence of multiple unique clock signals results in a number of clock boundaries being present in the graphics processing device. These multiple clock boundaries, or domains, can increase the cost of the graphics processing device and/or hamper performance. Performance can be hampered because hardware and/or software elements often must be purely devoted to handling clock domain crossings (e.g., when data is passed from one pipeline to another).

### BRIEF SUMMARY

What is needed are methods and systems that reduce clock domain crossings in computing devices which include graphics processing devices. In embodiments described herein, a graphics processing device is provided that includes a global clock generator and a plurality of graphics pipelines. The global clock generator produces a global clock signal, which is used to provide timing signals to each of the graphics pipelines. Because the timing signals on which each pipeline operates is derived from a common global clock signal, the number of clock domain crossings can be substantially reduced.

In an embodiment, a graphics processing device is provided. The graphics processing device includes a global clock generator configured to generate a global clock signal and a plurality of graphics pipelines each configured to transmit image frames to a respective display device, and in some embodiments, display those transmitted image frames. Each of the graphics pipelines comprises a timing generator. Each of the timing generators is configured to generate a respective virtual clock signal based on the global clock signal and wherein each virtual clock signal is used to advance logic of a respective one of the display devices.

In another embodiment, a method of generate controlling display devices is provided. The method includes generating a global clock signal and generating a virtual clock signal for each pipeline of a plurality of graphics pipelines based on the global signal. Each virtual clock signal is used to advance logic of a respective display device.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the pertinent art to make and use the invention. Various embodiments of the present invention are described below with reference to the drawings, wherein like reference numerals are used to refer to like elements throughout.

FIG. 1 is an illustrative block diagram of a conventional graphics processing device coupled to a plurality of display devices.

FIG. 2 is an illustrative block diagram of a graphics processing device coupled to a plurality of display devices, according to an embodiment of the present invention.

FIGS. 3-4 are illustrative block diagrams of timing generators, according to embodiments of the present invention.

FIG. 5 is an exemplary timing diagram illustrating the operation of an exemplary synchronization circuit, according to an embodiment of the present invention.

FIG. 6 is a flowchart illustrating an exemplary method for controlling display devices, according to an embodiment of the present invention.

### DETAILED DESCRIPTION

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

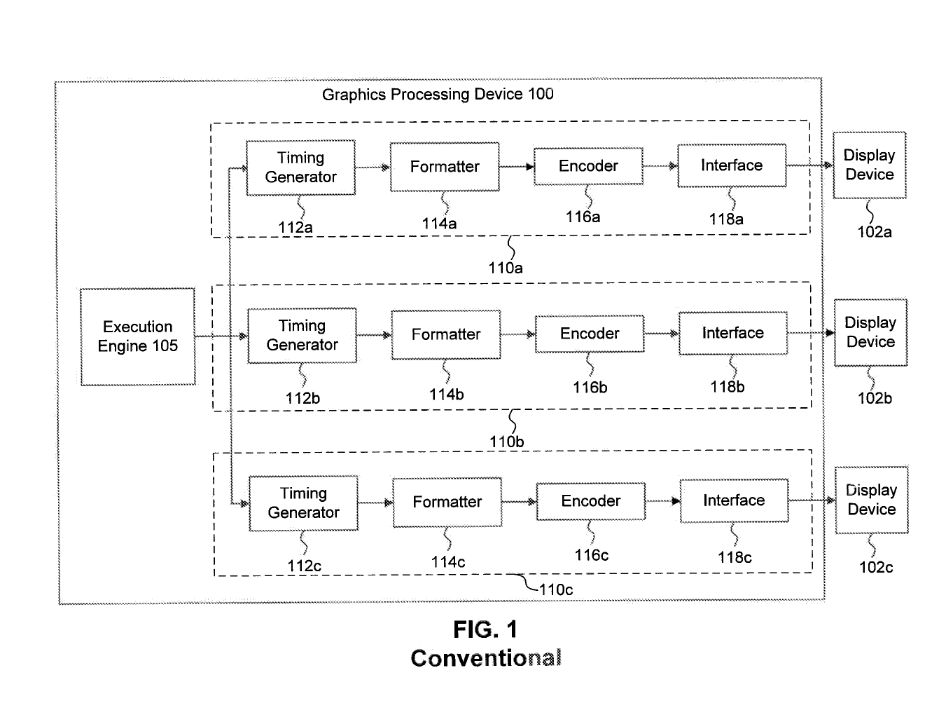

FIG. 1 is a block diagram illustration of a conventional graphics processing device 100 coupled to display devices 102a, 102b, and 102c (collectively “display devices 102”). Graphics processing device 100 includes an execution engine 105 and graphics pipelines 110a, 110b, and 110c (collectively “graphics pipelines 110”). Graphics pipelines 110a, 110b, and 110c include timing generators 112a, 112b, and 112c (collectively “timing generators 112”), formatters 114a, 114b, and 114c (collectively “formatters 114”), encoders 116a, 116b, and 116c (collectively “encoders 116”), and interfaces 118a, 118b, and 118c (collectively “interfaces 118”), respectively.

Execution engine 105 generates image frames to be displayed on display devices 102. For example, graphics processing device 100 can receive commands from another processing device (e.g., a central processing unit (CPU)). In response to these commands, execution engine 105 can generate image frame data. After execution engine 105 generates an image frame, execution engine 105 sends the image frame to one or more of graphics pipeline of graphics pipelines 110. Graphics pipelines 110 control a respective one of display devices 102 to display the image frame information. Display devices 102 can include a variety of different types of display devices. For example, display devices 102 can include a computer monitor, a television, or other similar display devices.

Timing generators 112 are configured to generate timing signals that are used to advance logic in a respective display device 102. For example, each of timing generators 112 can include a phase lock loop (PLL), a crystal oscillator, or some other type of oscillator. Each of the PLLs can be used to generate a respective clock signal for a graphics pipeline. These clock signals can, in turn, be used to generate timing signals, e.g., v_sync and h_sync signals, that advance logic of a respective display device. For example, the logic of the display device can include row and column drivers that control the state of individual pixels of the display device.

The rate of each clock signal can be chosen to accommodate a respective display device 102. For example, timing generators 112 (and their respective PLLs) can be configured to generate clock signals at a one of a plurality of different rates to accommodate different types of display devices 102. For example, graphics processing device 100 can receive signals from display devices 102 via interfaces 118. In one exemplary embodiment, a user using display device 102a can select a particular display setting (e.g., 1080P). Display device 102a uses this input, based upon this setting, to generate a signal that is received by graphics processing device 100 through interface 118a. Based on information extracted from these signals, timing generator 112 chooses a rate for the clock signal that is appropriate to achieve the desired display setting.

Formatters 114 format image frames data so that they can be displayed on the respective display device 102. For example, formatters 114 can format image frames for display on a particular screen size and resolution. Encoders 116 receive formatted image frames and encode the image frames according to encoding techniques that can be decoded by respective ones of display devices 102. As described above, interfaces 118 enable communication between display devices 102 and graphics processing device 100. For example, interfaces are used to communicate the formatted and encoded image frame data to respective display devices 102. In an embodiment, interfaces 118 can control a number of different buses that communicate data to and from respective display devices 102. For example, interfaces 118 can control a main link bus, an auxiliary link bus, and/or a hot plug detect to communicate information to display device 102.

As described above, each of graphics pipelines 110 control respective display devices 102 to display respective image frames received from execution engine 105. In addition to being separate pipelines, each of graphics pipelines 110 are also separate clock domains. In particular, each of graphics pipelines 110 include a respective timing generator 112, which produces a unique clock tailored to its respective display device 102. Although the use of a unique clock provides flexibility needed so that different display devices can be driven with respective rates, the presence of multiple clock boundaries within graphics processing device 100 greatly adds to the complexity of the system. For example, complex hardware is required to facilitate communication between pipelines when each of the pipelines operates according to its own unique clock signal. In particular, clock domain crossing hardware is needed to facilitate communication between pipelines when each operates according to a unique clock. This clock domain crossing hardware can be burdensome and costly.

In embodiments described herein, a graphics processing device is provided that includes a global clock generator and a plurality of graphics pipelines. The global clock generator is configured to generate a global clock signal. Timing generators included in each of the graphics pipelines of the graphics processing device use this global clock signal to generate a virtual clock signal that is used to advance logic of a respective display device. Because each pipeline operates according to a virtual clock associated with the same global clock signal, clock domain crossings between pipelines can be eliminated. Thus, unlike conventional graphics processing devices which have a separate clock domain for each graphics pipeline, such as device 100 described above, embodiments of the present invention can have only one global clock domain. This accommodation reduces the complexity of the overall system while enhancing overall performance.

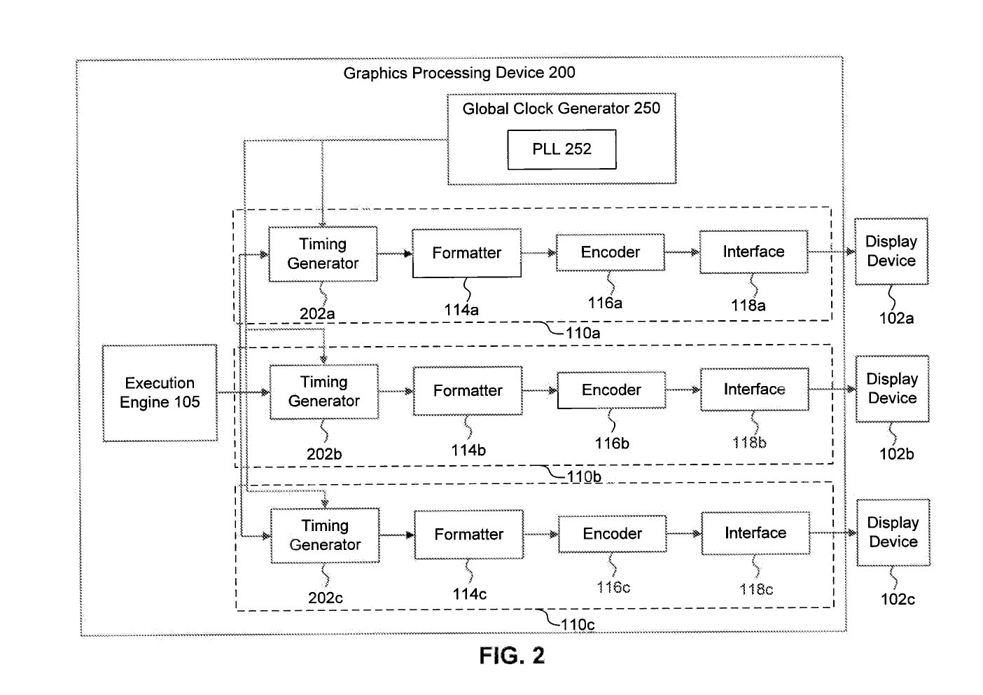

FIG. 2 is a block diagram illustration of a graphics processing device 200 coupled to display devices 102, according to an embodiment of the present invention. Graphics processing device 200 includes execution engine 105, graphics pipelines 210a, 210b, and 210c (collectively “graphics pipelines 210”), and a global clock generator 250. Graphics pipelines 210 transmit image frames to respective ones of display devices 102. For example, graphics pipelines 210a, 210b, and 210c can be similar to graphic pipelines 110a, 110b, and 110c, respectively, except that timing generators 112a, 112b, and 112c, are replaced with timing generators 202a, 202b, and 202c, respectively (collectively “timing generators 202”).

Global clock generator 250 includes a PLL 252. PLL 252 can include a crystal, or other oscillator, upon which PLL 252 generates the global clock signal. As will be described in greater detail below, the global clock signal is used to generate virtual clock signals for each of graphics pipelines 210. PLL 252 is configured to generate a global clock signal which is sufficient for the operation of each of graphics pipelines 210. For example, PLL 252 can be configured to generate the global clock signal such that the rate of the global clock is high enough to accommodate the rates needed by each of graphics pipelines 210. In particular, each of timing generators 202 can be configured to generate their respective virtual clock signal at a rate that can be expressed as a fraction of the global clock signal. In such an embodiment, the global clock signal should be at a high enough rate so that each of timing generators 202 can generate an appropriate virtual clock signal. Put another way, PLL 252 can be configured such that the rate of the global clock signal is greater than or equal to the rate needed by any of display devices 102.

FIG. 2 is an illustrative embodiment in which global clock generator 250 includes PLL 252. In alternate embodiments, other clock signal generating elements can be used to generate the global clock signal. Moreover, FIG. 2 is an illustration in which global clock generator 250 is fully separate from graphics pipelines 210. However, in an alternate embodiment, global clock generator 250 can be integrated within one of graphics pipelines 210.

For example, global clock generator 250 can be integrated within timing generator 202a of graphics pipeline 210a. In such an embodiment, the clock domain of graphics processing device 200 is determined based on the clock signal generated by timing generator 202a. In a further embodiment, timing generator 202a can also be configured to generate a virtual clock signal based on its own generated clock signal. In still another embodiment, other clock generation hardware located in graphics processing device 200 can be used for global clock generator 250.

For example, execution engine 105 can include clock generation hardware capable of producing the global clock signal. Using components internal to graphics processing device 200, instead of including an additional global clock generator, can save board space in graphics processing device 200. Moreover, as would be appreciated by those skilled in the relevant art, clock generation systems can be relatively high power devices. As such, avoiding the use of an additional Clock generator, as achieved in embodiments of the present invention, can represent substantial power savings for graphics processing device 200.

Timing generators 202 receive a global clock signal from global clock generator 250. Each of timing generators 202 is configured to use the received global clock signal to generate a respective virtual clock signal. The virtual clock signals can be used to advance logic of a respective one of display devices 102. For example, the virtual clock signals can be used to generate v_sync and h_sync signals.

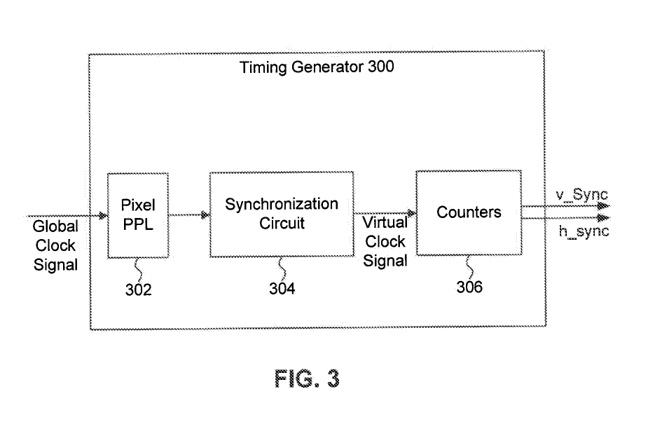

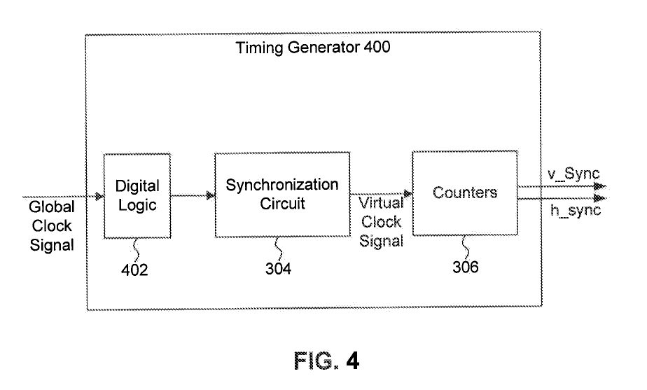

The virtual Clock signals each have a rate that is determined based on the characteristics of the respective display device 102. For example, as described above, each of display devices can transmit signals to graphics processing device 200 through interfaces 118. Based on these signals, timing generators can select an appropriate rate for their respective virtual clock signal. Unlike the conventional system depicted in FIG. 1, each of the clock signals used to drive display devices 102 are virtual clock signals generated based on the same global clock signal. In doing so, graphics pipelines 210 are all in the same clock domain. Thus, the complexities associated with clock domain crossings present in conventional graphics processing device 100, described with reference to FIG. 1, can be substantially reduced or eliminated. Exemplary structures for timing generators 202 are provided in FIGS. 3 and 4, described below.

FIG. 3 is a block diagram illustration of a timing generator 300, according to an embodiment of the present invention. Timing generator 300 includes a pixel PLL 302, a synchronization circuit 304, and counters 306. Pixel PLL 302 receives a global Clock signal (e.g., from global clock generator 250). Based on the received global clock signal, pixel PLL 302 generates a respective clock signal.

In an embodiment, the rate of the clock signal generated by pixel PLL 302 is determined based on characteristics of the respective display device. For example, the pixel PILL 302 can be configured to generate a clock signal at a specific rate based on the type of display and/or the standard at which the display device displays received image data. However, in generating the clock signal, pixel PLL 302 does not generate a unique clock. Rather, this clock is generated based on global clock signal received from global clock signal generator 250. Thus, pixel PLL 302 does not generate a new clock domain. Synchronization circuit 304 is configured to receive the clock signal generated by pixel PLL 302 and produce a virtual clock signal therefrom.

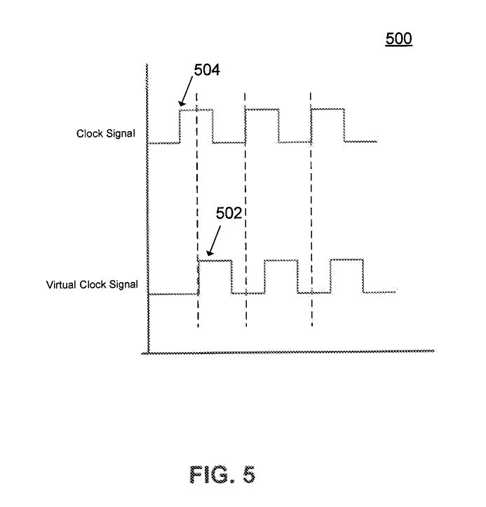

FIG. 5 is a timing diagram 500 illustrating operation of synchronization circuit 304, according to an embodiment of the present invention. The Clock Signal of FIG. 5 represents the clock signal generated by pixel PLL 302. The Virtual Clock Signal of FIG. 5 is generated by synchronization circuit 304.

Synchronization circuit 304, of FIG. 3, can be configured to generate strobes 502 in response to rising edges 504 of the clock signal. As such, the virtual clock signal is not an actual clock signal but rather a collection of strobes generated in response to rising edges of the actual clock signal.

The virtual clock signal generated by synchronization circuit 304 is received by counters 306. The counters 306 generate v_sync and h_sync signals based on the received virtual clock signal. In an embodiment, the v_sync signal determines when the respective display device transitions from one frame to another and the signal h_sync controls when the display device starts refreshing successive rows of the display.

FIG. 4 is a block diagram illustration of a timing generator 400, according to an embodiment of the present invention. Timing generator 400 is substantially similar to timing generator 300 of FIG. 3 except that pixel PLL 302 is replaced with digital logic 402. In an embodiment, digital logic 402 can be implemented using programmable hardware devices, such as complex programmable logic devices (CPLDs) or field programmable gate arrays (FPGAs).

Alternatively, digital logic 402 can be implemented as an application specific integrated circuit (ASIC). Like pixel PLL 302, digital logic 402 can be used to generate a clock signal based on the received global clock signal. In particular, digital logic 402 can store a specified ratio in a memory and generate the clock signal having a rate equal to the ratio multiplied with the rate of the global clock signal. As would be appreciated by those skilled in the relevant art based on the description herein, a PLL, and particularly voltage control oscillators included in PLLs, take up substantial space and consume relatively large amounts of power. Thus, using digital logic 402 instead of pixel PLL 302, thereby reducing the total number of PLLs, can save space and reduce system power consumption. Moreover, digital logic 402 may be better suited to maintain a specific frequency relative to the global clock signal over a period of time. A tradeoff exists, however, because pixel PLL 302 may be better suited to provide short term accurate clock signals.

Thus, FIGS. 3 and 4 provide examples of timing generators having different examples of clock generators (e.g., pixel PLL 302 and digital logic 402). As would be apparent to those skilled in the art, other types of clock generators can be used for timing without departing from the scope and spirit of the present invention.

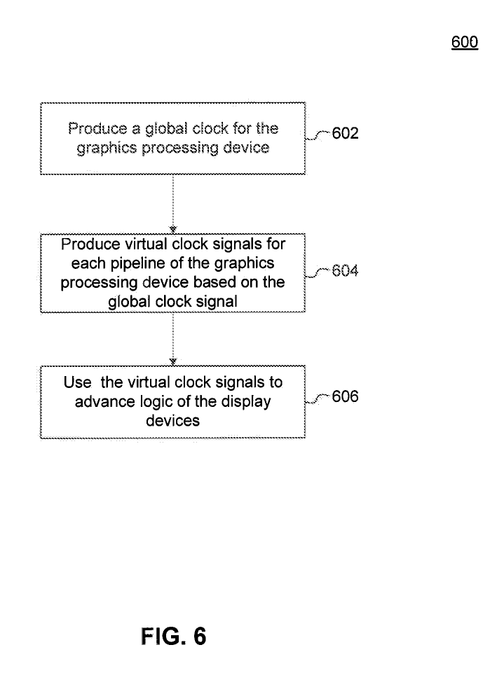

FIG. 6 is a flowchart 600 of an exemplary method of practicing an embodiment of the present invention. More specifically, the flowchart 600 includes example steps for processing memory requests. Other structural and operational embodiments will be apparent to persons skilled in the relevant art(s) based on the following discussion. The steps shown in FIG. 6 are not necessarily required to occur in the order shown.

In step 602, a global clock is produced. For example, in FIG. 2, global clock generator 250 produces a global clock signal.

In step 604, virtual clock signals are produced for each pipeline of the graphics processing device based on the global clock signal. For example, in FIG. 2, timing generators 202 can produce respective virtual clock signals based on the received global clock signal.

In step 606, the virtual clock signals are used to advance logic of a display device. For example, in FIG. 2, the virtual clock signals generated by timing generators 202 can be used to generate respective v_sync and h_sync signals. The v_sync and h_sync signals can be used are used to advance logic (e.g., row and column drivers) of display devices 102.

The present invention may be embodied in hardware, software, firmware, or any combination thereof. Embodiments of the present invention or portions thereof may be encoded in many programming languages such as hardware description languages (HDL), assembly language, C language, and netlists etc. For example, an HDL, e.g., Verilog, can be used to synthesize, simulate, and manufacture a device, e.g., a processor, application specific integrated circuit (ASIC), and/or other hardware element, that implements the aspects of one or more embodiments of the present invention. Verilog code can be used to model, design, verify, and/or implement a processor that can scale frames using content-aware seam carving.

For example, Verilog can be used to generate a register transfer level (RTL) description of logic that can be used to execute instructions so that a frame can be scaled using content-aware seam carving. The RTL description of the logic can then be used to generate data, e.g., graphic design system (GDS) or GDS II data, used to manufacture the desired logic or device. The Verilog code, the RTL description, and/or the GDS II data can be stored on a computer readable medium. The instructions executed by the logic to perform aspects of the present invention can be coded in a variety of programming languages, such as C and C++, and compiled into object code that can be executed by the logic or other device.

Aspects of the present invention can be stored, in whole or in part, on a computer readable media. The instructions stored on the computer readable media can adapt a processor to perform the invention, in whole or in part, or be adapted to generate a device, e.g., processor, ASIC, other hardware, that is specifically adapted to perform the invention in whole or in part. These instructions can also be used to ultimately configure a manufacturing process through the generation of maskworks/photomasks to generate a hardware device embodying aspects of the invention described herein.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A computing system, comprising:
a global clock generator configured to produce a global clock signal; and
a plurality of graphics pipelines each configured to transmit image frames to a respective display device, each of the graphics pipelines including a timing generator; and
wherein each of the timing generators is configured to produce a respective virtual clock signal based on the global clock signal.

2. The computing system of claim 1 further comprising at least two display devices, one of said at least two display devices connected to a first of said plurality of graphics pipelines and a second of said at least two display devices connected to a second of said plurality of graphics pipelines and wherein at least said first and second of said at least two display devices display the transmitted image frames from the respective first and second of said plurality of graphics pipelines.

3. The computing system of claim 1, wherein each virtual clock signal is used to advance logic of a respective one of the display devices.

4. The computing system of claim 1, wherein the global clock generator comprises a phase lock loop (PLL).

5. The computing system of claim 1, wherein at least one of the timing generators comprises:
a clock generator configured to generate a clock signal based on the global clock signal; and
a synchronization circuit configured generate a virtual clock signal based on the clock signal.

6. The computing system of claim 5, wherein the clock generator comprises a phase lock loop (PLL) configured to generate the clock signal based on the global clock signal.

7. The computing system of claim 5, wherein the clock generator comprises digital logic configured to generate a clock signal based on the global clock signal.

8. The computing system of claim 7, wherein the digital logic circuit is configured to generate the clock signal at a rate relative to the global clock signal based on a stored value.

9. The computing system of claim 5, wherein the synchronization circuit is configured to generate a virtual clock signal of the virtual clock signals as a plurality of strobes.

10. The computing system of claim 9, wherein the synchronization circuit is configured to the plurality of strobes based on a plurality of rising edges of the clock signal.

11. The computing system of claim 5, further comprising:
a plurality of counters configured to generate timing signals.

12. The computing system of claim 11, wherein the timing signals comprise at least one of a v_sync signal or an h_sync signal.

13. The computing system of claim 1, wherein each of the virtual clock signals comprises a plurality of strobes.

14. The computing system of claim 1, wherein the global clock generator is configured to generate the global clock signal at a rate sufficient to accommodate each of the graphics pipelines.

15. The computing system of claim 1, wherein each of the graphics pipelines comprises an encoder.

16. The computing system of claim 1, wherein each of the graphics pipelines is configured to receive the image frames from an execution engine.

17. The computing system of claim 16, wherein the execution engine is configured to generate the image frames based on one or more commands received from another processing device.

18. A method of controlling display devices, comprising:
producing a global clock signal; and
producing a virtual clock signal for each pipeline of a plurality of graphics pipelines based on the global signal.

19. The method of claim 18, wherein each virtual clock signal is used to advance logic of a respective display device.

20. The method of claim 18, further comprising:
producing a timing signal based at least one of the virtual clock signals.

21. The method of claim 20, wherein the timing signal comprises a v_sync signal or an h_sync signal.

22. The method of claim 18, wherein producing the virtual clock comprises:
producing a virtual clock signal comprising a plurality of strobes.

23. The method of claim 18, wherein producing the virtual clock signal comprises:
producing a clock signal based on the global clock signal for each pipeline; and
producing each virtual clock signal as a plurality of strobes based on rising edges of a respective one of the clock signals.

24. A computer program product comprising a non-transitory computer readable storage medium having control logic stored therein for causing the control of display devices by a computing system:
first computer readable program code means for causing the computer to produce a global clock signal; and
second computer readable program code means for causing the computer to produce a virtual clock signal for each pipeline of a plurality of graphics pipelines based on the global signal.

25. The computer readable storage medium of claim 24, further comprising:
third computer readable program code means for causing the computer to produce a timing signal based at least one of the virtual clock signals.

26. The computer readable storage medium of claim 24, further comprising:
fourth computer readable program code means for causing the computer to produce a virtual clock signal comprising a plurality of strobes.

27. The computer readable storage medium of claim 24, further comprising:
fifth computer readable program code means for causing the computer to produce a clock signal based on the global clock signal for each pipeline; and
sixth computer readable program code means for causing the computer to produce each virtual clock signal as a plurality of strobes based on rising edges of a respective one of the clock signals.

28. The computer readable medium of claim 24, wherein the computing system is embodied in hardware description language software.

29. The computer readable medium of claim 24, wherein the computing system is embodied in one of Verilog hardware description language software and VHDL hardware description language software.
